(19) United States
(12) Patent Application Publication
(10) Pub. No.: US 2024/0085869 A1
(43) Pub. Date: Mar. 14, 2024

(54) AI BASED METHOD AND SYSTEM FOR PREDICTING AN INTERNAL STATE OF A MACHINE

(71) Applicant: Panasonic Intellectual Property Management Co., Ltd., Osaka (JP)

(72) Inventors: Sourabh Balasaheb JAGADALE, Singapore (SG); Kyaw Myo HTUN, Singapore (SG); Faye JULIANO, Singapore (SG); Myo MIN LATT, Singapore (SG); Eng Chye LIM, Singapore (SG)

(21) Appl. No.: 17/942,792

(22) Filed: Sep. 12, 2022

(51) Int. Cl. G05B 13/04; G05B 13/02

(52) U.S. Cl. CPC G05B 13/048; G05B 13/0265

(57) ABSTRACT

Provided is a method for predicting an internal state of a machine. The method includes obtaining real time machine test data from a plurality of sensors installed in a test bench of the machine and identifying differences between the obtained real time machine test data and simulation data of a machine model. The method further includes updating the machine model by eliminating the identified differences and generating synthetic data corresponding to each of a normal condition and at least one deteriorated condition of the machine using the updated machine model. The method further includes detecting one or more deterioration levels of the machine over a period of time along with timestamp data based on a plurality of machine parameters using an Artificial Intelligence (AI) model and predicting a deterioration time period of the machine indicating an RUL of the machine based on the detected deterioration levels.

### FIELD OF THE INVENTION

The present disclosure relates to the field of artificial intelligence (AI). In particular, the present invention relates to an AI based method and system for predicting an internal state of a machine.

### BACKGROUND

Prediction of machine state, which consists of machine anomalies and Remaining Useful Life (RUL) of the machine, requires a vast amount of data over the lifetime of the machine. The lifetime of machines is usually in years. For this reason, it is not always feasible to get the data of machines that are suitable for predictive maintenance.

Solutions to predict the state of the machine using synthetic data from simulation models were previously proposed in the existing state of the art. RUL prediction requires the health status data of the machine and timestamps when each health status is recorded. Using simulation, synthetic data of an unhealthy (deteriorated) machine can be generated but how fast the machine will deteriorate depends on the operating conditions of the machine. Hence, using the simulation a prediction that how fast a particular machine will deteriorate is not possible.

Therefore, there lies a need for a method and system that can overcome the aforementioned problem while predicting the RUL of the machine.

### SUMMARY

This summary is provided to introduce a selection of concepts in a simplified format that are further described in the detailed description of the invention. This summary is not intended to identify key or essential inventive concepts of the invention, nor is it intended for determining the scope of the invention.

In order to provide solutions for the aforementioned problems discussed in the background section, the present disclosure describes a computer implemented method and a system for predicting an internal state of a machine.

The computer implemented method for predicting the internal state of the machine includes obtaining real time machine test data from a plurality of sensors installed in a test bench of the machine and identifying differences between the obtained real time machine test data and simulation data of a machine model based on a comparison of the obtained real time machine test data with the simulation data. The method further includes updating the machine model by eliminating the identified differences between the obtained real time machine test data and the simulation data. The updated machine model includes a plurality of machine fault models. The method further includes generating, using the updated machine model, synthetic data. corresponding to each of a normal condition of at least one machine and at least one deteriorated condition of the at least one machine. The generated synthetic data includes information related to a plurality of machine parameters. Subsequent to the generation of the synthetic data, the method further includes detecting, based on the information related to the plurality of machine parameters, at least one deterioration level of the at least one machine over a period of time along with timestamp data using an Artificial Intelligence (AI) model, and thereafter predicting, based on the at least one detected deterioration level of the at least one machine at a corresponding timestamp included in the timestamp data, a deterioration time period of the at least one machine that indicates an RUL of the at least one machine.

In another implementation, the system for predicting the internal state of the machine includes a plurality of sensors installed in a test bench of the machine, at least one controller, and a training engine including an Artificial Intelligence (AI) module. The at least one controller is configured to obtain real time machine test data from the plurality of sensors and identify differences between the obtained real time machine test data and simulation data of a machine model based on a comparison of the obtained real time machine test data with the simulation data. The at least one controller is further configured to control the training engine to update the machine model by eliminating the identified differences between the obtained real time machine test data and the simulation data. The updated machine model includes a plurality of machine fault models. The at least one controller is further configured to generate, using the updated machine model, synthetic data corresponding to each of a normal condition of at least one machine and at least one deteriorated condition of the at least one machine. The generated synthetic data includes information related to a plurality of machine parameters. The at least one controller is further configured to detect, based on the information related to the plurality of machine parameters, at least one deterioration level of the at least one machine over a period of time along with timestamp data using an AI model of the AI module, and thereafter predict a deterioration time period of the at least one machine based on the at least one detected deterioration level of the at least one machine at a corresponding timestamp included in the timestamp data. The deterioration time period of the at least one machine indicates a Remaining Useful Life (RUL) of the at least one machine.

To further clarify the advantages and features of the present invention, a more particular description of the invention will be rendered by reference to specific embodiments thereof, which is illustrated in the appended drawing. It is appreciated that these drawings depict only typical embodiments of the invention and are therefore not to be considered limiting its scope. The invention will be described and explained with additional specificity and detail with the accompanying drawings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of a system architecture illustrating an AI based system for predicting an internal state of the machine, in accordance with an embodiment of the present disclosure;

FIG. 2 is a block diagram illustrating a feedback mechanism, in accordance with an embodiment of the present disclosure;

FIG. 3 is a flowchart of method steps for predicting the internal state of the machine, in accordance with an embodiment of the present disclosure;

FIGS. 4A, 4B, and 4C illustrate examples of distributed faults in the motor caused due to electrolytic corrosion, in accordance with an embodiment of the present disclosure;

FIGS. 5A, 5B, and 5C illustrate examples of concentrated faults in the motor caused due to load shocks, in accordance with an embodiment of the present disclosure;

FIGS. 5D and 5E illustrate examples of crack faults in the motor, in accordance with an embodiment of the present disclosure;

FIG. 6 is an architectural diagram depicting an example of a DC motor, in accordance with an embodiment of the present disclosure; and

FIG. 7 illustrates an example of an RUL curve of the motor that is constructed based on the historical records of HI and the corresponding timestamps, in accordance with an embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION

It should be understood at the outset that although illustrative implementations of the embodiments of the present disclosure are illustrated below, the present invention may be implemented using any number of techniques, whether currently known or in existence. The present disclosure should in no way be limited to the illustrative implementations, drawings, and techniques illustrated below, including the exemplary design and implementation illustrated and described herein, but may be modified within the scope of the appended claims along with their full scope of equivalents.

The term “some” as used herein is defined as one, or more than one, or all.” Accordingly, the terms “one,” “more than one,” “more than one, or “all” would all fall under the definition of “some,” The term “some embodiments” may refer to one embodiment or several embodiments or all embodiments. Accordingly, the term some embodiments” is defined as meaning “one embodiment, or more than one embodiment, or all embodiments.”

The terminology and structure employed herein are for describing, teaching, and illuminating some embodiments and their specific features and elements and do not limit, restrict, or reduce the spirit and scope of the claims or their equivalents.

More specifically, any terms used herein such as but not limited to “includes,” “comprises,” “has,” “have” and grammatical variants thereof do NOT specify an exact limitation or restriction and certainly do NOT exclude the possible addition of one or more features or elements, unless otherwise stated, and must NOT be taken to exclude the possible removal of one or more of the listed features and elements, unless otherwise stated with the limiting language “MUST comprise” or “NEEDS TO include.”

Whether or not a certain feature or element was limited to being used only once, either way, it may still be referred to as “one or more features” or “one or more elements” or “at least one feature” or “at least one element.” Furthermore, the use of the terms “one or more” or “at least one” feature or element do NOT preclude there being none of that feature or element unless otherwise specified by limiting language such as “there NEEDS to be one or more . . . ” or “one or more element is required.”

The term “module” and “engine” used in the present document may imply a unit including, for example, one of hardware, software, and firmware or a combination of two or more of them. The “module” and “engine” may be interchangeably used with a term such as logic, a logical block, a component, a circuit, and the like. The “module” and “engine” may be a minimum system component for performing one or more functions or may be a part thereof For example, the “module” and “engine” of the present disclosure may include at least one of an Application-Specific Integrated Circuit (ASIC) chip, a Field-Programmable Gate Arrays (FPGAs), programmable-logic device, or a combination of programmable-logic devices which are known or will be developed, and which perform certain operations.

Unless otherwise defined, all terms, and especially any technical and/or scientific terms, used herein may be taken to have the same meaning as commonly understood by one having ordinary skill in the art.

Embodiments of the present invention will be described below in detail with reference to the accompanying drawings.

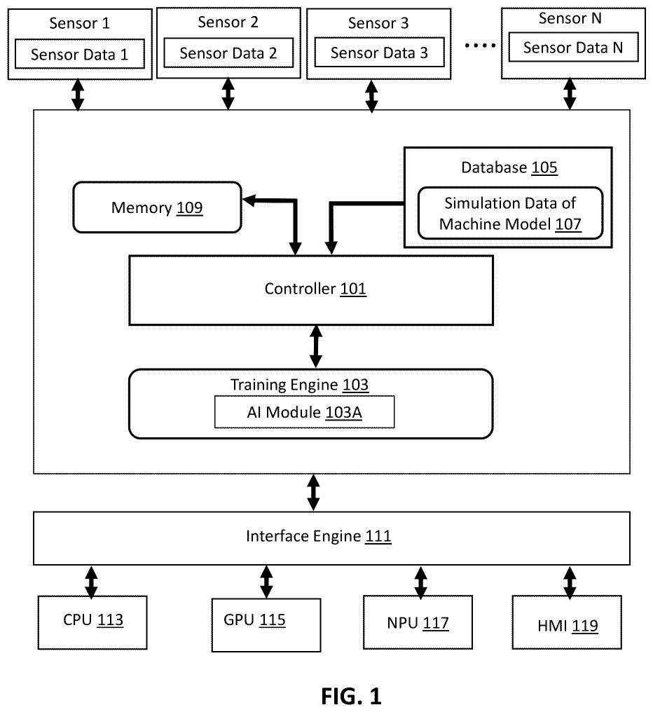

FIG. 1 is a block diagram of a system architecture illustrating an AI based system for predicting a Remaining Useful Life (RUL) of a machine, in accordance with an embodiment of the present disclosure. The system includes a plurality of sensors (sensor 1, sensor 2, sensor 3, . . . , sensor N, a controller 101, a training engine 103 including an AI module 103A, a database 105 having simulation data of machine model 107 stored therein i.e., simulation data related to a simulation model of a motor, a memory 109, and an interface engine 111 connected to various processing units, such as a central processing unit (CPU) 113, a graphics processing unit (GPU) 115, and a neural processing unit (NPU) 117, and a human machine interface (HMI) 119, etc.

The plurality of sensors (sensor 1, sensor 2, sensor 3, . . . , sensor N) is installed in a test bench of the machine (although not shown in FIG. 1) and configured to collect real time machine test data and send the collected real time machine test data to the controller 101 for further processing. This collected data is appropriately processed via the controller 101 to predict the RUL of the machine during operation. Here, the machine test bench corresponds to a motor testbench for gathering the actual motor data.

According to an embodiment, a 300 W DC motor is used as an example for predicting the RUL. However, this example is not limited in scope, and the RUL of other machines and devices can also be predicted using the method and system described in the present disclosure.

The controller 101 can be a single processing unit or a combination of several processing units, all of which could include multiple computing modules. The controller 101 may be implemented as one or more microprocessors, microcomputers, microcontrollers, digital signal processors, central processing units, state machines, logic circuitries, and/or any devices that manipulate signals based on operational instructions. Among other capabilities, the controller 101 is configured to fetch and execute computer-readable instructions and data that are stored in the memory 109 and the database 105.

The training engine 103 is configured to train AI models of the AI module 103A based on the instructions under the control of the controller 101. The training engine may update parameters related to the simulation data of machine model 107 by eliminating a difference between the obtained real time machine test data and the simulation data. In an embodiment, the computations involved in the training process of the AI module 103A may be achieved by extending the inference engine. Here, “training” means that a predefined operation rule or artificial intelligence model configured to perform the desired feature (or purpose) is obtained by training a basic artificial intelligence model with multiple pieces of training data by a training technique. The learning may be performed in the system itself in which AI according to an embodiment is performed, and/or may be implemented through a separate server/system.

The AI module 103A may consist of a plurality of neural network layers. Each layer has a plurality of weight values and performs a neural network layer operation through calculation between a result of computation of a previous layer and an operation of a plurality of weights. In particular, the AI module 103A may include AI models that are used by the controller 101 for the detection of deterioration levels of the least one machine (Motor) over a period of time along with timestamp data. The AI models may include, but are not limited to, Ensemble models, support vector machines (SVM) based models, and neural network (NN) models including at least one of wide neural network (WNN) model, bilayer neural network (BNN) model, and medium neural network model.

The memory 109 may include but is not limited to computer-readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one example, memory 109 includes a cache or random-access memory for the controller 101. The memory 109 is operable to store instructions executable by the controller. The functions, acts or tasks illustrated in the figures or described may be performed by the programmed controller 101 for executing the instructions stored in the memory 109. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing and the like.

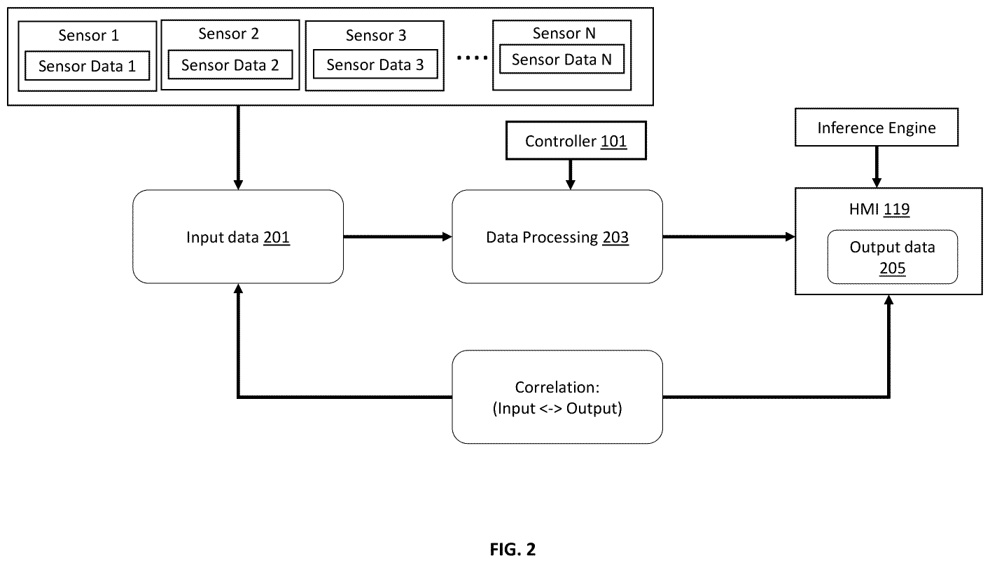

FIG. 2 is a block diagram of an information processing example performed by the system of FIG. 1, in accordance with an embodiment of the present disclosure. FIG. 2 depicts the processing of input data 201 by a method of data processing 203 to generate output data 205 using which indicates the RUL of the machine. The input data 201 includes synthetic data that is generated from models of the machines (motor models) and sensor data collected by the plurality of sensors (sensor 1, sensor 2, . . . , sensor N) from the machine test bench (motor test bench).

The data processing 203 includes anomaly detection and classification of motor models based on large scale synthetic data (to be described later in the present disclosure) and anomaly detection and faults level classification of real time data collected by the plurality of sensors from machines. The results of the data processing are provided to the interface engine 111. The output data includes data that indicates the RUL of the machine based on the data processing results. The output data is provided on the HMI 119 connected to the interface engine 111.

Further, the RUL is correlated to how healthy the machine is based on the real-time sensor feedback. For example, RUL is correlated to a health index of the machine based on a correlation between the input data 201 and the output data 203.

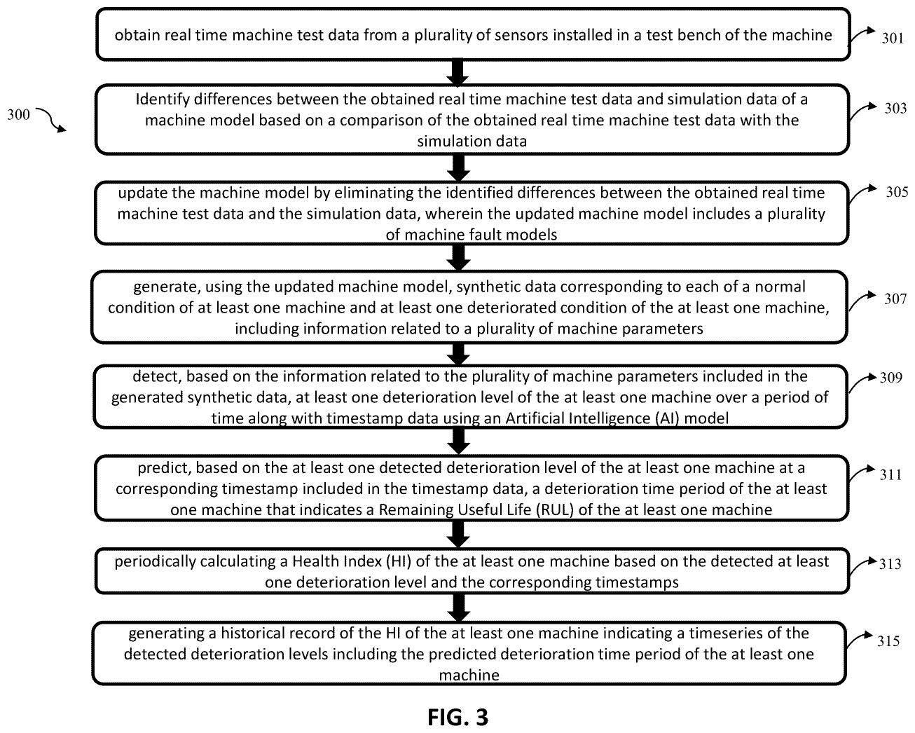

Further, the functionalities of the controller 101 and the training engine 103 along with other components of the system of FIG. 1 will be explained with reference to the method steps of FIG. 3 of the drawings.

FIG. 3 illustrates a flowchart of method steps for predicting, the RUL of the machine, in accordance with an embodiment of the present disclosure. FIG. 3 depicts a method 300 that is executed by the controller 101 in combination with the AI module 103A of the system of FIG. 1 of the drawings.

The method 300 as depicted in FIG. 3, at step 301, comprises obtaining real time machine test data from the plurality of sensors that are installed in the motor test bench. As an example, sensor 1, sensor 2, . . . , and sensor N collects real time machine test data from the motor test bench and then provide the collected real time machine test data to the controller 101 for further processing. An example of the real time machine test data is shown below in Table 1. Those skilled in the art will appreciate that the aforementioned example of the real time machine test data is merely exemplary and is not intended to limit the scope of the invention. In the below shown Table 1, CH1 indicates a current (Ia) in Phase A (first phase) of the motor, CH2 indicates a current (Ib) in Phase B (second phase) of the motor, CH3 indicates a current (Ic) in Phase C (third phase) of the motor, and CH4 indicates a DC voltage (Vdc) of the motor. The real time machine test data may further include a variety of feature signals corresponding to the motor and these signals can be used by the controller 101 to identify key differences between the real time machine test data and the simulation data of the machine model stored in the database 105. The controller 101 may acquire the simulation data of various machine models stored in the database 105 to identify the key differences and a deviation from the real time machine test data. The simulation data of the machine model may include, for example, but are not limited to, an Input Voltage (Pe) of the motor, a speed of the motor, an Input Current (Iin) of the motor, phase currents of the motor. The flow of the method 300 now proceeds to (step 303).

TABLE 1
Example of Real-time Machine Test Data

| 21 | TIME | CH1 | CH2 | CH3 | CH4 |
|---|---|---|---|---|---|
| 22 | −5.00E−01 | 3.04 | −0.08 | 0.06 | 148 |
| 23 | −5.00E−01 | 3.04 | −0.08 | 0.14 | 140 |
| 24 | −5.00E−01 | 3.12 | 0 | 0.06 | 132 |
| 25 | −5.00E−01 | 3.2 | −0.08 | 0.1 | 140 |
| 26 | −5.00E−01 | 3.6 | −0.04 | 0.06 | 140 |
| 27 | −5.00E−01 | 3.2 | −0.08 | 0.06 | 140 |
| 28 | −4.99E−01 | 3.2 | −0.08 | 0.14 | 148 |
| 29 | −4.99E−01 | 3.04 | −0.08 | 0.02 | 132 |
| 30 | −4.99E−01 | 3.12 | −0.08 | 0.1 | 140 |
| 31 | −4.99E−01 | 3.12 | −0.08 | 0.1 | 140 |
| 32 | −4.99E−01 | 3.12 | −0.04 | 0.1 | 140 |
| 33 | −4.99E−01 | 3.04 | −0.08 | 0.1 | 140 |
| 34 | −4.99E−01 | 3.2 | −0.08 | 0.1 | 140 |
| 35 | −4.99E−01 | 3.04 | −0.08 | 0.1 | 140 |
| 36 | −4.99E−01 | 3.12 | −0.08 | 0.02 | 140 |
| 37 | −4.99E−01 | 3.12 | −0.04 | 0.1 | 148 |
| 38 | −4.98E−01 | 2.64 | −0.08 | 0.1 | 140 |
| 39 | −4.98E−01 | 3.04 | −0.08 | 0.14 | 140 |
| 40 | −4.98E−01 | 3.2 | −0.08 | 0.1 | 132 |

At step 303, subsequent to the acquisition of the simulation data of the machine model and real time machine test data, the method 300 comprises identifying differences between the obtained real time machine test data and the simulation data of the machine model by comparing the obtained real time machine test data with the simulation data. As an example, the controller identifies the differences between the real time machine test data obtained from the plurality of sensors and the simulation data acquired from the database 105. The flow of the method 300 now proceeds to (step 305).

At the step 305, subsequent to the identification of the key differences between the real time machine test data and the simulation data, the method 300 comprises updating the machine model by eliminating the identified differences between the real time machine test data and the simulation data. As an example, the controller 101 controls the training engine 103 to update the motor model, whereas the AI module 103A of the training engine 103 updates the motor model by eliminating the identified differences between the real time machine test data and the simulation data. In particular, the AI module 103A includes a plurality of machine fault models into the motor model to generate an updated motor model. The flow of the method 300 now proceeds to (step 307).

At the step 307, after the machine model is updated, the method 300 comprises generating, using the updated machine model, synthetic data corresponding to each of a normal condition of at least one machine and at least one deteriorated condition of the at least one machine. As an example, the controller is configured to generate the synthetic data corresponding to each of the normal condition of the motor and at least one deteriorated condition of the motor using the updated motor model. The generated synthetic data includes information related to a plurality of machine parameters including but not limited to, an Input Voltage (Pe) of the motor, a running speed of the motor, an input current (Iin) of the motor, and a plurality of phase currents of the motor (a current (Ia) in the Phase A of the motor, a current (Ib) in the Phase B of the motor, and a current (Ic) in the Phase C of the motor. For each of the machine related parameters, the generated synthetic data includes a plurality of signal features. For example, features that are generated from Signal la include but are not limited to a clearance factor, crest factor, impulse factor, kurtosis, mean, peak value, Root-mean-square (RMS), Signal to noise and distortion ratio (SINAD), Signal-to-noise ratio (SNR), shape factor, skewness, standard deviation, Total harmonic distortion (THD). An example Table 2 is shown below to illustrate an example of the generated synthetic data. Those skilled in the art will appreciate that the aforementioned example of the synthetic data illustrated in Table 2 is merely exemplary and is not intended to limit the scope of the invention.

TABLE 2
Example of Synthetic Data
1320 × 11 table

| | 1 | 2 | 3 | 4 | 5 | 6 |
|---|---|---|---|---|---|---|
| | [symbol] a | [symbol] b | [symbol] c | [symbol] | [symbol] e | speed |
| 1 | 4001 × 1 tim . . . | 4001 × 1 tim . . . | 4001 × 1 tim . . . | 4001 × 1 tim . . . | 4001 × 1 tim . . . | 4001 × 1 tim . . . |
| 2 | 4001 × 1 tim . . . | 4001 × 1 tim . . . | 4001 × 1 tim . . . | 4001 × 1 tim . . . | 4001 × 1 tim . . . | 4001 × 1 tim . . . |
| 3 | 4001 × 1 tim . . . | 4001 × 1 tim . . . | 4001 × 1 tim . . . | 4001 × 1 tim . . . | 4001 × 1 tim . . . | 4001 × 1 tim . . . |
| 4 | 4001 × 1 tim . . . | 4001 × 1 tim . . . | 4001 × 1 tim . . . | 4001 × 1 tim . . . | 4001 × 1 tim . . . | 4001 × 1 tim . . . |
| 5 | 4001 × 1 tim . . . | 4001 × 1 tim . . . | 4001 × 1 tim . . . | 4001 × 1 tim . . . | 4001 × 1 tim . . . | 4001 × 1 tim . . . |
| 6 | 4001 × 1 tim . . . | 4001 × 1 tim . . . | 4001 × 1 tim . . . | 4001 × 1 tim . . . | 4001 × 1 tim . . . | 4001 × 1 tim . . . |
| 7 | 4001 × 1 tim . . . | 4001 × 1 tim . . . | 4001 × 1 tim . . . | 4001 × 1 tim . . . | 4001 × 1 tim . . . | 4001 × 1 tim . . . |
| 8 | 4001 × 1 tim . . . | 4001 × 1 tim . . . | 4001 × 1 tim . . . | 4001 × 1 tim . . . | 4001 × 1 tim . . . | 4001 × 1 tim . . . |
| 9 | 4001 × 1 tim . . . | 4001 × 1 tim . . . | 4001 × 1 tim . . . | 4001 × 1 tim . . . | 4001 × 1 tim . . . | 4001 × 1 tim . . . |
| 10 | 4001 × 1 tim . . . | 4001 × 1 tim . . . | 4001 × 1 tim . . . | 4001 × 1 tim . . . | 4001 × 1 tim . . . | 4001 × 1 tim . . . |
| 11 | 4001 × 1 tim . . . | 4001 × 1 tim . . . | 4001 × 1 tim . . . | 4001 × 1 tim . . . | 4001 × 1 tim . . . | 4001 × 1 tim . . . |
| 12 | 4001 × 1 tim . . . | 4001 × 1 tim . . . | 4001 × 1 tim . . . | 4001 × 1 tim . . . | 4001 × 1 tim . . . | 4001 × 1 tim . . . |
| 13 | 4001 × 1 tim . . . | 4001 × 1 tim . . . | 4001 × 1 tim . . . | 4001 × 1 tim . . . | 4001 × 1 tim . . . | 4001 × 1 tim . . . |
| 14 | 4001 × 1 tim . . . | 4001 × 1 tim . . . | 4001 × 1 tim . . . | 4001 × 1 tim . . . | 4001 × 1 tim . . . | 4001 × 1 tim . . . |
| 15 | 4001 × 1 tim . . . | 4001 × 1 tim . . . | 4001 × 1 tim . . . | 4001 × 1 tim . . . | 4001 × 1 tim . . . | 4001 × 1 tim . . . |
| 16 | 4001 × 1 tim . . . | 4001 × 1 tim . . . | 4001 × 1 tim . . . | 4001 × 1 tim . . . | 4001 × 1 tim . . . | 4001 × 1 tim . . . |
| 17 | 4001 × 1 tim . . . | 4001 × 1 tim . . . | 4001 × 1 tim . . . | 4001 × 1 tim . . . | 4001 × 1 tim . . . | 4001 × 1 tim . . . |
| 18 | 4001 × 1 tim . . . | 4001 × 1 tim . . . | 4001 × 1 tim . . . | 4001 × 1 tim . . . | 4001 × 1 tim . . . | 4001 × 1 tim . . . |
| 19 | 4001 × 1 tim . . . | 4001 × 1 tim . . . | 4001 × 1 tim . . . | 4001 × 1 tim . . . | 4001 × 1 tim . . . | 4001 × 1 tim . . . |
| 20 | 4001 × 1 tim . . . | 4001 × 1 tim . . . | 4001 × 1 tim . . . | 4001 × 1 tim . . . | 4001 × 1 tim . . . | 4001 × 1 tim . . . |
| 21 | 4001 × 1 tim . . . | 4001 × 1 tim . . . | 4001 × 1 tim . . . | 4001 × 1 tim . . . | 4001 × 1 tim . . . | 4001 × 1 tim . . . |
| 22 | 4001 × 1 tim . . . | 4001 × 1 tim . . . | 4001 × 1 tim . . . | 4001 × 1 tim . . . | 4001 × 1 tim . . . | 4001 × 1 tim . . . |

| | 7 | 8 | 9 | 10 | 11 |
|---|---|---|---|---|---|
| | b1_x | b1_y | b2_x | b2_y | FaultCode |
| 1 | 4001 × 1 tim . . . | 4001 × 1 tim . . . | 4001 × 1 tim . . . | 4001 × 1 tim . . . | 10 |
| 2 | 4001 × 1 tim . . . | 4001 × 1 tim . . . | 4001 × 1 tim . . . | 4001 × 1 tim . . . | 10 |
| 3 | 4001 × 1 tim . . . | 4001 × 1 tim . . . | 4001 × 1 tim . . . | 4001 × 1 tim . . . | 10 |
| 4 | 4001 × 1 tim . . . | 4001 × 1 tim . . . | 4001 × 1 tim . . . | 4001 × 1 tim . . . | 10 |
| 5 | 4001 × 1 tim . . . | 4001 × 1 tim . . . | 4001 × 1 tim . . . | 4001 × 1 tim . . . | 10 |
| 6 | 4001 × 1 tim . . . | 4001 × 1 tim . . . | 4001 × 1 tim . . . | 4001 × 1 tim . . . | 10 |
| 7 | 4001 × 1 tim . . . | 4001 × 1 tim . . . | 4001 × 1 tim . . . | 4001 × 1 tim . . . | 10 |
| 8 | 4001 × 1 tim . . . | 4001 × 1 tim . . . | 4001 × 1 tim . . . | 4001 × 1 tim . . . | 10 |
| 9 | 4001 × 1 tim . . . | 4001 × 1 tim . . . | 4001 × 1 tim . . . | 4001 × 1 tim . . . | 10 |
| 10 | 4001 × 1 tim . . . | 4001 × 1 tim . . . | 4001 × 1 tim . . . | 4001 × 1 tim . . . | 10 |
| 11 | 4001 × 1 tim . . . | 4001 × 1 tim . . . | 4001 × 1 tim . . . | 4001 × 1 tim . . . | 10 |
| 12 | 4001 × 1 tim . . . | 4001 × 1 tim . . . | 4001 × 1 tim . . . | 4001 × 1 tim . . . | 10 |
| 13 | 4001 × 1 tim . . . | 4001 × 1 tim . . . | 4001 × 1 tim . . . | 4001 × 1 tim . . . | 10 |
| 14 | 4001 × 1 tim . . . | 4001 × 1 tim . . . | 4001 × 1 tim . . . | 4001 × 1 tim . . . | 10 |
| 15 | 4001 × 1 tim . . . | 4001 × 1 tim . . . | 4001 × 1 tim . . . | 4001 × 1 tim . . . | 10 |
| 16 | 4001 × 1 tim . . . | 4001 × 1 tim . . . | 4001 × 1 tim . . . | 4001 × 1 tim . . . | 10 |
| 17 | 4001 × 1 tim . . . | 4001 × 1 tim . . . | 4001 × 1 tim . . . | 4001 × 1 tim . . . | 10 |
| 18 | 4001 × 1 tim . . . | 4001 × 1 tim . . . | 4001 × 1 tim . . . | 4001 × 1 tim . . . | 10 |
| 19 | 4001 × 1 tim . . . | 4001 × 1 tim . . . | 4001 × 1 tim . . . | 4001 × 1 tim . . . | 10 |
| 20 | 4001 × 1 tim . . . | 4001 × 1 tim . . . | 4001 × 1 tim . . . | 4001 × 1 tim . . . | 10 |
| 21 | 4001 × 1 tim . . . | 4001 × 1 tim . . . | 4001 × 1 tim . . . | 4001 × 1 tim . . . | 10 |
| 22 | 4001 × 1 tim . . . | 4001 × 1 tim . . . | 4001 × 1 tim . . . | 4001 × 1 tim . . . | 10 |

[symbol]

indicates data missing or illegible when filed

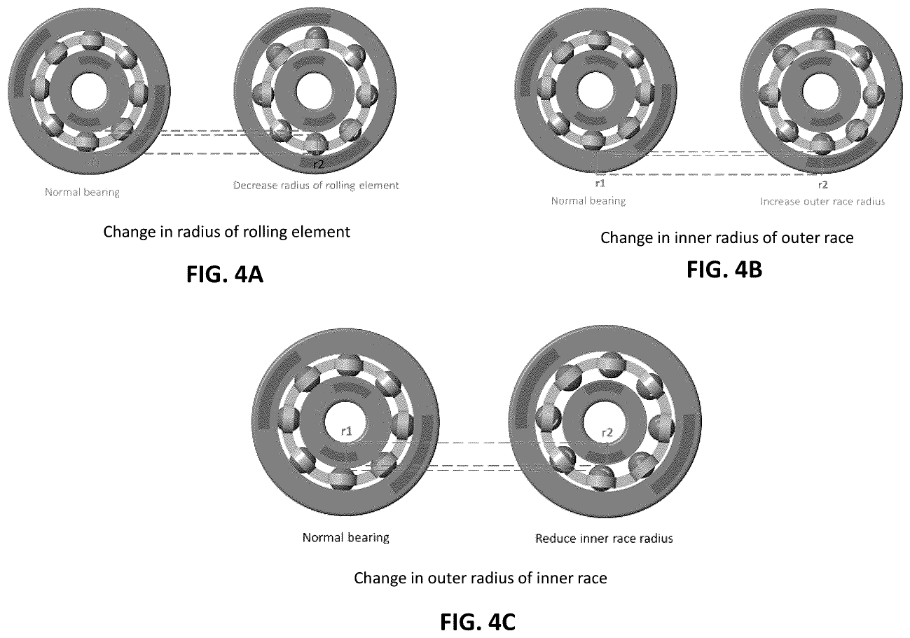

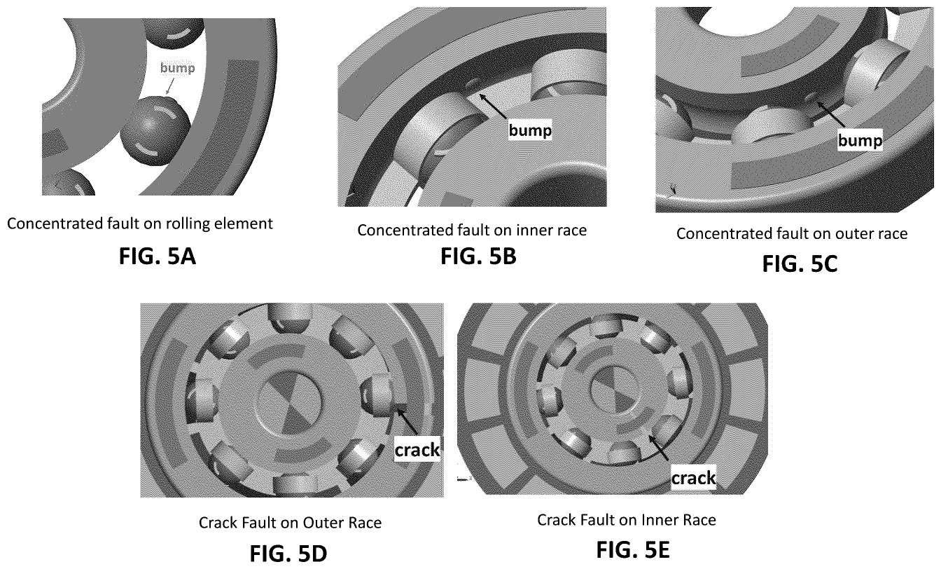

According to some embodiment of the present disclosure, the controller 101 further generates the synthetic data including a plurality of deteriorated. conditions of the motor based on the updated motor model. The deteriorated conditions of the motor may include but are not limited to distributed faults in the motor caused due to electrolytic corrosion, concentrated faults in the motor caused due to load shocks, and crack faults. FIGS. 4A, 4B, and 4C of the drawings illustrate examples of the distributed faults in the motor caused due to electrolytic corrosion, in accordance with an embodiment of the present disclosure. As per FIGS. 4A. 4B, and 4C, the distributed faults in the motor may include but are not limited to a change in the radius of the rolling element, a change in the inner radius of the outer race, and a change in the outer radius of the inner race. Further, FIGS, 5A 5B, and 5C illustrate examples of concentrated faults in the motor caused due to load shocks, in accordance with an embodiment of the present disclosure. As per FIGS. 5A-5C, the concentrated faults in the motor may include but are not limited to a concentrated fault on the rolling element of the motor, a concentrated. fault on the inner race, and a concentrated fault on the outer race. Further, FIGS. 5D and 5E illustrate examples of crack faults in the motor, in accordance with an embodiment of the present disclosure. As per FIGS. 5D and 5E, the crack faults include but are not limited to a crack fault on the outer race and a crack fault on the inner race.

Also, the controller 101 is further configured to generate the synthetic data based on the simulation data of the motor model, and the training engine 103 trains the AI model of the AI module 103A based on the synthetic data that is generated using the simulation data of the motor model. The AI model corresponds to a self-learning-based classification model that is trained at a plurality of predefined deterioration levels based on the generated synthetic data, and the controller 101 is further configured to classify the real time machine test data using the trained AI model. The flow of the method 300 now proceeds to (step 309).

At the step 309, subsequent to the generation of the synthetic data, the method 300 comprises detecting, based on the information related to the plurality of machine parameters included in the generated synthetic data, at least one deterioration level of the at least one machine over a period of time along with timestamp data using the AI model of the AI module 103A. The timestamp data includes a plurality of timestamps each indicating a time at which the at least one deterioration level of the at least machine is detected. As an example, the controller 101 detects, using the AI model based on an analysis of the plurality of deteriorated conditions of the motor, one or more deterioration levels of the motor over the period of time along with corresponding timestamps. In particular, the at least one deterioration level of the motor is detected over the period of time by using the self-learning-based classification model for the analysis of the plurality of deteriorated conditions of the motor.

According to some embodiment of the present disclosure, the controller 101 may be configured to detect the one or more deterioration levels of the motor along with timestamp data using the AI model based on a result of a comparison between the synthetic data corresponding to the normal motor condition and the synthetic data corresponding to the deteriorated conditions of the motor.

An example of the one or more deterioration levels of the motor for each of the above-mentioned motor faults depicted in example FIGS. 4A-4C and 5A-5E is illustrated in Table 3 below. Those skilled in the art will appreciate that the below-mentioned example of the one or more deterioration levels illustrated in Table 3 is merely exemplary and is not intended to limit the scope of the invention.

Further, an example illustrating different types of motor faults with respect to FIGS. 4A-4C and FIGS. 5A-5E is shown below in Table 4. Those skilled in the art will appreciate that the below-mentioned example of the motor faults illustrated in Table 4 is merely exemplary and is not intended to limit the scope of the invention.

TABLE 3

| Deterioration level | Min air gap |
|---|---|
| 0% | >90% of gap_normal |
| 10% | ≤90% of gap_normal |
| | >80% of gap_normal |
| 20% | ≤80% of gap_normal |
| | >70% of gap_normal |
| 30% | ≤70% of gap_normal |
| | >60% of gap_normal |
| . . . | . . . |
| 70% | ≤30% of gap_normal |
| | >20% of gap_normal |
| 80% | ≤20% of gap_normal |
| | >10% of gap_normal |
| 90% | ≤10% of gap_normal |
| | >0% of gap_normal |
| 100% | 0 |

TABLE 4

| | | | |
|---|---|---|---|
| Ball radius | 0.9r-1r | 2 [symbol] 0 V- [symbol] 40 V | 0-1.8 N · m |
| | (11 levels) | (10 levels) | (10 levels) |
| Inner race radius | 1r-1.16r | | |
| | (11 levels) | | |
| Outer race radius | 0.34r-1r | | |
| | (11 levels) | | |
| Bump on ball | 0-1 mm | | |
| | (11 levels) | | |
| Bump on inner race | 0-1 mm | | |
| | (11 levels) | | |
| Bump on outer race | 0-1 mm | | |
| | (11 levels) | | |
| Crack on inner race | 0°-20° | | |
| | (11 levels) | | |
| Crack on outer race | 0°-20° | | |
| | (11 levels) | | |

[symbol]

indicates data missing or illegible when filed

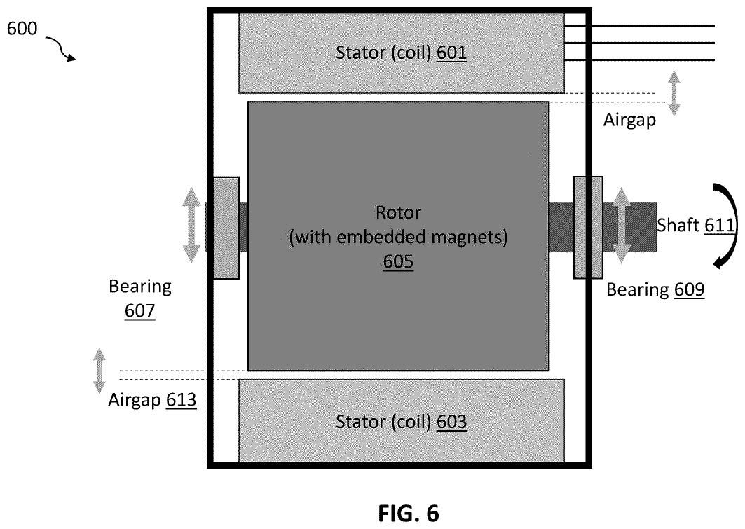

Now, a deteriorated condition of the motor will be explained with reference to FIG. 6 of the drawings. FIG. 6 is an architectural diagram depicting an example of a DC motor, in accordance with an embodiment of the present disclosure. FIG. 6 illustrates a DC motor 600 including a set of stator coils 601 and 603, a rotor with embedded magnets 605, and a set of bearings 607 and 609 on both sides of the shaft 611. As shown in FIG. 6, when the bearings deteriorate, an airgap 613 around the rotor 605 is not uniform. This effect is reflected in the phase currents of the motor which is one of a machine parameter among the plurality of machine parameters. Therefore, the deterioration condition of the motor can be indicated by the generated synthetic data. The flow of the method 300 now proceeds to (step 311).

At the step 311, subsequent to the detection of the one or more deterioration levels, the method 300 comprises predicting, based on the one or more detected deterioration levels of the at least one machine at the corresponding timestamp included in the timestamp data, a deterioration time period of the at least one machine. In particular, as an example, the controller 101 is configured to predict the deterioration time period of the motor based on the detected deterioration levels of the motor at the corresponding timestamps. The flow of the method 300 now proceeds to (step 313). The deterioration time period indicates the RUL of the motor. The RUL of the motor corresponds to a time duration after the expiry of which a condition of the motor exceeds a deterioration threshold level. The deterioration threshold level is a predefined threshold level that is set based on the analysis of the synthetic data and corresponds to a specific threshold value corresponding to a failure of the motor.

At the step 313, subsequent to the prediction of the deterioration time period of the at least one machine, the method 300 comprises periodically calculating. a Health Index (HI) of the at least one machine based on the one or more detected deterioration levels of the at least one machine and the corresponding timestamps at which the one or more deterioration levels are detected. As an example, the controller 101 is configured to calculate the HI of the motor based on the one or more deterioration levels of the motor as per the classification (for example, class 0 to class 10) done using the trained AI model and the corresponding timestamps at which the one or more deterioration levels of the motor were detected. A value of the calculated HI of the motor indicates one of a normal motor or a faulty motor. For example, class 0 of the motor means healthy motor, and class 10 of the motor means faulty motor. Hence, for class 0, a value of the HI will be 1, and for class 10, a value of the HI will be 0. The flow of the method 300 now proceeds to (step 315).

At the step 315, subsequent to the calculation of the HI, the method 300 comprises generating a historical record of the HI of the at least one machine by periodically storing. the calculated HI in the database 105 along with the timestamps at Which the HI of the at least one machine is calculated. As an example, the calculated. HI of the motor is stored periodically in the database 105, and based on the stored calculated HI, the controller is configured to generate the historical record of the HI in a form of an RUL curve, and thereafter display the RUL curve indicating a time-series of HI on a display screen of the HMI 119 by controlling the interface engine 111. In particular, the historical record of the HI indicates a time series of the detected deterioration levels including the predicted deterioration time period of the motor. Hence, based on the historical records of HI and the corresponding timestamps, the time required to reach the deterioration threshold level of the motor can be easily predicted.

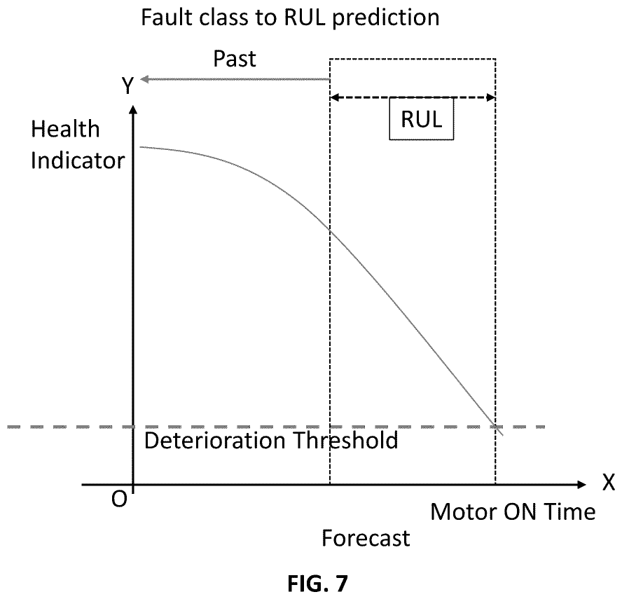

FIG. 7 illustrates an example of an RUL curve of the motor that is constructed based on the historical records of HI and the corresponding timestamps, in accordance with an embodiment of the present disclosure.

Therefore, in accordance with the above-mentioned method for predicting the internal state of the machine, it became possible to predict how fast a particular machine will deteriorate with the help of the real time machine test data and the generated synthetic data.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

We claim:

1. A computer implemented method for predicting an internal state of a machine, comprising:
obtaining real time machine test data from a plurality of sensors installed in a test bench of the machine:
identifying differences between the obtained real time machine test data and simulation data of a machine model based on a comparison of the obtained real time machine test data with the simulation data;
updating the machine model by eliminating the identified differences between the obtained real time machine test data and the simulation data, wherein the updated machine model includes a plurality of machine fault models;
generating, using the updated machine model, synthetic data corresponding to each of a normal condition of at least one machine and at least one deteriorated condition of the at least one machine, wherein the generated synthetic data includes information related to a plurality of machine parameters;
detecting, based on the information related to the plurality of machine parameters included in the generated synthetic data, at least one deterioration level of the at least one machine over a period. of time along with timestamp data using an Artificial Intelligence (AI) model; and
predicting, based on the at least one detected deterioration level of the at least one machine at a corresponding timestamp included in the timestamp data, a deterioration time period of the at least one machine that indicates a Remaining Useful Life (RUL) of the at least one machine.

2. The method as claimed in claim 1, wherein
the timestamp data includes a plurality of timestamps each indicating a time at which the at least one deterioration level of the at least one machine is detected,
the AI model corresponds to a self-learning based classification model that is trained at a plurality of predefined deterioration levels based on the generated synthetic data, and
the method further comprises detecting, based on the information related to the plurality of machine parameters, the at least one deterioration level of the at least one machine over the period of time using the self-learning based classification model.

3. The method as claimed in claim 1, further comprising:
periodically calculating a Health Index (HI) of the at least one machine based on the detected at least one deterioration level and the corresponding timestamps at which the at least one deterioration level is detected; and
generating a historical record of the HI of the at least one machine by periodically storing the calculated HI in a database along with timestamps at which the HI of the at least one machine is calculated, wherein the historical record of the HI indicates a time-series of the detected deterioration levels including the predicted deterioration time period of the at least one machine.

4. The method as claimed in claim 3, wherein a value of the calculated HI of the at least one machine indicates one of a normal machine or a faulty machine.

5. The method as claimed in claim 1, further comprising:
detecting, using the AI model based on a result of a comparison between the synthetic data corresponding to the normal condition of at least one machine and the synthetic data corresponding to the at least one deteriorated condition of the at least one machine, the at least one deterioration level of the at least one machine along with timestamp data.

6. The method as claimed in claim 1, wherein
the simulation data includes simulation results of the machine model,
the machine model corresponds to a motor model, and
the plurality of machine parameters includes at least one of a phase current, an input voltage, and a speed of the at least one machine.

7. The method as claimed in claim 1, wherein
the RUL of the at least one machine corresponds to a time duration after expiry of which the at least one machine exceeds a deterioration threshold level, and
the deterioration threshold level corresponds to a specific threshold corresponding to a failure of the at least one machine.

8. The method as claimed in claim 1, wherein the real time machine test data corresponds to data collected by the plurality of sensors in real time.

9. The method as claimed in claim 1, further comprising:
generating, using the updated machine model, synthetic data that includes a plurality of deteriorated conditions of the at least one machine;
detecting, using the AI model based on an analysis of the plurality of deteriorated conditions of the at least one machine, a plurality of deterioration levels of the at least one machine over a period of time along with corresponding timestamps; and
predicting the deterioration time period of the at least one machine based on the detected plurality of deterioration levels.

10. The method as claimed in claim 1, further comprising:
generating the synthetic data based on the simulation data of the machine model;
training the AI model based on the synthetic data that is generated using the simulation data of the machine model; and
classifying, using the trained AI model, the real time machine test data that is obtained from the plurality of sensors.

11. A system for predicting an internal state of a machine, comprising:
a plurality of sensors installed in a test bench of the machine;
at least one controller; and
a training engine including an Artificial Intelligence (AI) module, wherein the at least one controller is configured to:
obtain real time machine test data from the plurality of sensors;
identify differences between the obtained real time machine test data and simulation data of a machine model based on a comparison of the obtained real time machine test data with the simulation data;
control the training engine to update the machine model by eliminating the identified differences between the obtained real time machine test data and the simulation data, wherein the updated machine model includes a plurality of machine fault models;
generate, using the updated machine model, synthetic data corresponding to each of a normal condition of at least one machine and at least one deteriorated condition of the at least one machine, wherein the generated synthetic data includes information related to a plurality of machine parameters;
detect, based on the information related to the plurality of machine parameters included in the generated synthetic data, at least one deterioration level of the at least one machine over a period of time along with timestamp data using an AI model of the AI module; and
predict, based on the at least one detected deterioration level of the at least one machine at a corresponding timestamp included in the timestamp data, a deterioration time period of the at least one machine that indicates a Remaining Useful Life (RUL) of the at least one machine.

12. The system as claimed in claim 11, further comprises a database configured to store the simulation data of the machine model, wherein the at least one controller is further configured to acquire the simulation data of the machine model from the database.

13. The system as claimed in claim 11, wherein
the timestamp data includes a plurality of timestamps each indicating a time at which the at least one deterioration level of the at least one machine is detected,
the AI model corresponds to a self-learning based classification model that is trained at a plurality of predefined deterioration levels based on the generated synthetic data, and
the at least one controller is further configured to detect, based on the information related to the plurality of machine parameters, the at least one deterioration level of the at least one machine over the period of time using the self-learning based classification model.

14. The system as claimed in claim 11, wherein the at least one controller is further configured to:
periodically calculate a Health index (HI) of the at least one machine based on the detected at least one deterioration level and the corresponding timestamps at which the at least one deterioration level is detected; and
generate a historical record of the HI of the at least one machine by periodically storing the calculated HI in a database along with timestamps at which the HI of the at least one machine is calculated, wherein the historical record of the HI indicates a time-series of the detected deterioration levels including the predicted deterioration time period of the at least one machine.

15. The system as claimed in claim 14, wherein a value of the calculated HI of the at least one machine indicates one of a normal machine or a faulty machine.

16. The system as claimed in claim 11, wherein the at least one controller is further configured to:
detect, using the AI model based on a result of a comparison between the synthetic data corresponding to the normal condition of at least one machine and the synthetic data corresponding to the at least one deteriorated condition of the at least one machine, the at least one deterioration level of the at least one machine along with timestamp data.

17. The system as claimed in claim 11, wherein the at least one controller is further configured to:
generate, using the updated machine model, synthetic data that includes a plurality of deteriorated conditions of the at least one machine:
detect, using the AI model based on an analysis of the plurality of deteriorated conditions of the at least one machine, a plurality of deterioration levels of the at least one machine over a period of time along with corresponding timestamps; and
predict the deterioration time period of the at least one machine based on the detected plurality of deterioration levels.

18. The system as claimed in claim 11, wherein the at least one controller is further configured to:
generate the synthetic data based on the simulation data of the machine model;
train the AI model based on the synthetic data that is generated using the simulation data of the machine model; and
classify, using the trained AI model, the real time machine test data that is obtained from the plurality of sensors.
